(19) United States
(12) Patent Application Publication
(10) Pub. No.: US 2014/0331854 A1
(43) Pub. Date: Nov. 13, 2014

(54) APPARATUS FOR AND METHOD OF ATTACHING A PISTON TO A CYLINDER ROD

(71) Applicants: Jason R. Coombs, Bismarck, ND (US); Scott N. Schuh, Bismarck, ND (US); Thomas J. Tokach, Mandan, ND (US)

(72) Inventors: Jason R. Coombs, Bismarck, ND (US); Scott N. Schuh, Bismarck, ND (US); Thomas J. Tokach, Mandan, ND (US)

(21) Appl. No.: 14/145,552

(22) Filed: Dec. 31, 2013

Related U.S. Application Data
(60) Provisional application No. 61/821,502, filed on May 9, 2013.

(51) Int. Cl. F16J 10/02

(52) U.S. Cl. CPC F16J 10/02
USPC 92/169.1

(57) ABSTRACT

Disclosed embodiments include hydraulic cylinder assemblies and piston assemblies for use in hydraulic cylinder assemblies. A rod is attached to a piston. The rod has first portion, a second portion with a cross-sectional area that is less than a cross-sectional area of the first portion, and a third portion positioned between the first and second portions. The third portion has a cross-sectional area that transitions between the cross-sectional area of the first portion and the cross-sectional area of the second portion. A collar is sized to fit over the rod with an internal feature that engages the third portion of the rod. A fastener holds the piston against the collar and provides a clamp force on the piston.

### CROSS-REFERENCE TO RELATED APPLICATION

The present application is based on and claims the benefit of U.S. provisional patent application Ser. No. 61/821,502, filed May 9, 2013, the content of which is hereby incorporated by reference in its entirety.

### FIELD

Disclosed embodiments relate to hydraulic cylinders, for example the types of hydraulic cylinders used on power machines.

### BACKGROUND

Power machines such as skid steer loaders, excavators, utility vehicles and the like typically utilize hydraulic cylinders as actuators for raising and lowering lift arms. For this use, cylinders are often referred to as lift cylinders. Some power machines also utilize hydraulic cylinders to tilt or rotate an attached implement relative to the portion of the power machine to which the implement is attached. For example, the orientation of a bucket implement or a blade implement can be controlled with a hydraulic cylinder that is coupled to the implement or an implement carrier to which the implement is attached. For this use, hydraulic cylinders are often referred to as tilt cylinders.

Hydraulic cylinders of the type used on power machines and for other uses have a cylinder body in the form of a tube or barrel that defines a cavity with a piston that is moveable within the cavity, the position of the piston being controlled by the introduction and evacuation of hydraulic fluid within the cavity on either side of the piston. A rod or shaft is attached to the piston and movement of the piston within the cylinder body causes the rod to extend out of and retract into the cylinder body. A connection feature on each of the cylinder body and the rod allows the cylinder to be attached to, for example a frame and a lift arm (or a lift arm and an implement carrier) such that movement of the piston and by extension, movement of the rod causes movement of one body (i.e. the lift arm) relative to the other (i.e. the frame).

In prior designs, the cylinder rod includes a shank portion that extends through the piston and is fastened to the piston via a fastener. A partially cut away drawing of a prior art cylinder is illustrated in FIG. 1. The rod has a shoulder at the beginning of the shank portion that absorbs the clamp load applied to the piston by securing the fastener to the rod.

This arrangement provides very little surface area to absorb the clamp load, which limits the amount of clamp load that can be applied to the piston. Increasing the surface area of the shoulder to allow for increased clamp load is made at expense of the width of the shank, thereby leaving the shank susceptible to yielding.

The discussion above is merely provided for general background information and is not intended to be used as an aid in determining the scope of the claimed subject matter.

### SUMMARY

Disclosed embodiments include hydraulic cylinders and piston assemblies for use in hydraulic cylinders. In one embodiment, a hydraulic cylinder assembly is disclosed. The hydraulic cylinder assembly includes a cylinder body that defines a cavity and a piston that is positioned and moveable within the cavity. The assembly further includes a rod having a first portion, a second portion with a cross-sectional area that is less than a cross-sectional area of the first portion, and a third portion positioned between the first and second portions. The third portion has a cross-sectional area that transitions between the cross-sectional area of the first portion and the cross-sectional area of the second portion. A collar is sized to fit over the rod. The collar has an internal feature for engaging with the third portion of the rod. A fastener holds the piston against the collar and provides a clamp force on the piston.

In another embodiment, a piston assembly for use in with a hydraulic cylinder which provides a cavity is disclosed. The piston assembly includes a piston that can be positioned in the cavity of the hydraulic cylinder and a rod attached to the piston such that the rod is extendable into and retractable from the hydraulic cylinder as the piston moves within the cavity. The rod has a main portion with a first diameter, a shank with a second diameter that is less than the first diameter, and a tapered portion between the main portion and the shank. A collar is sized to fit over the shank. The collar has a tapered internal surface that is configured to engage with the tapered portion of the rod. A fastener holds the piston against the collar and provides a clamp force on the piston.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a partially cut away drawing of a prior art cylinder of the type used in power machines.

FIG. 2 is a side view of a representative power machine upon which hydraulic cylinders according to illustrated embodiment may be practiced.

FIG. 3 illustrates a cross-sectional view of a cylinder according to a first illustrative embodiment.

FIG. 4 is an enlarged view of a portion of the cylinder shown in FIG. 3 showing a piston and associated collar engaged with a piston rod.

FIG. 5 illustrates a portion of a cylinder showing a piston and collar engaged with a cylinder rod according to a second illustrative embodiment.

FIG. 6 is a flow diagram illustrating an example method of attaching a piston to a cylinder rod.

### DETAILED DESCRIPTION

The concepts discussed below are not limited in their application to the details of construction and the arrangement of components set forth in the following description or illustrated in the following drawings. Rather, these concepts can be practiced or carried out in various other ways, with the illustrative embodiments set forth herein being used to introduce and explain the concepts. The terminology used herein is for the purpose of description and should not be regarded as limiting. The use of “including,” “comprising,” or “having” and variations thereof herein is meant to encompass the items listed thereafter and equivalents thereof as well as additional items.

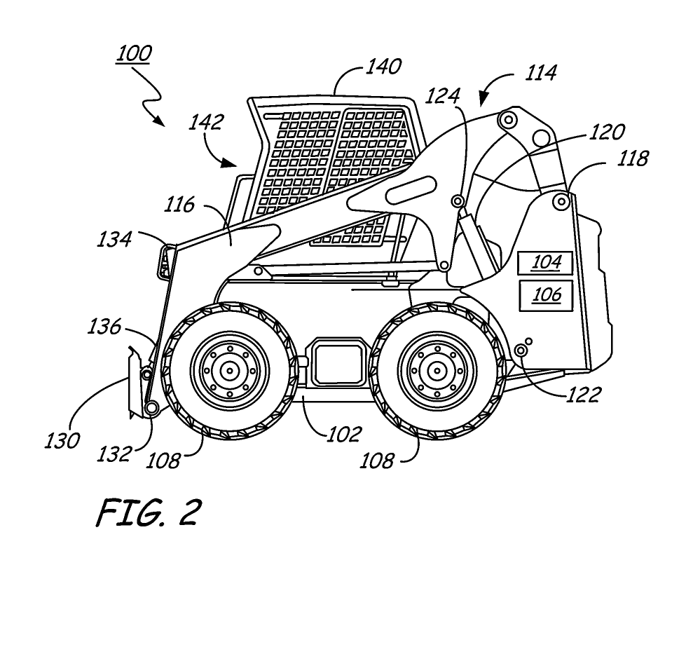

FIG. 2 is a side view of a representative power machine 100 upon which the disclosed hydraulic cylinder embodiments can be employed. The power machine 100 illustrated in FIG. 2 is a work vehicle in the form of a skid loader, but other types of work vehicles such as tracked loaders, steerable wheeled loaders including all-wheel steer loaders, excavators, and utility vehicles, to name but a few examples, may employ the disclosed hydraulic cylinder embodiments. In addition, the hydraulic cylinders of disclosed embodiments can be used for purposes other than power machines.

The power machine 100 includes a supporting frame or main frame 102, which supports a power source 104, which in some embodiments is an internal combustion engine. A control system 106 is operably coupled to the power source 104. Control system 106 illustratively receives power from the power source 104 and operator inputs to convert the received power to signals that operate functional components of the power machine. In some embodiments, such as with the power machine 100 in FIG. 2, the control system 106 includes hydraulic components such as one or more hydraulic pumps that are configured to provide pressurized hydraulic fluid to various actuators and valve components that are illustratively employed to control the flow of hydraulic fluid to some or all of the actuators used to control functional components of the power machine 100. Other types of control systems are contemplated. For example, the control system 106 can include electric generators or the like to generate electrical control signals to power electric actuators. For the sake of simplicity, the actuators disclosed herein are referred to as hydraulic or electrohydraulic actuators, but other types of actuators can be employed in some embodiments. However, at least some of the actuators used in power machine 100 are hydraulic cylinder actuators in accordance with disclosed embodiments described below.

Tractive elements 108 are operably coupled to the frame and are controllable by the control system 106 to selectively propel the power machine 100 over a support surface. A pair of tractive elements 108 in the form of wheels are shown in FIG. 2. The power machine 100 has a similar pair of wheels disposed on an opposite side of the frame 102. Other embodiments can have other tractive elements such endless tracks or a different number of wheels. For example, some embodiments include three or more wheels on each side of a given power machine.

The power machine 100 also includes a lift arm assembly 114 that is capable of being raised and lowered with respect to the frame 102. The lift arm assembly 114 illustratively includes a lift arm 116 that is pivotally attached to the frame 102 at attachment point 118. An actuator 120, which in exemplary embodiments is a hydraulic cylinder configured to receive pressurized fluid from control system 106, is pivotally attached to both the frame 102 and the lift arm 116 at attachment points 122 and 124, respectively. The lift arm 116 is representative of the type of lift arm that may be attached to the power machine 100. It should be appreciated that the lift arm assembly 114 shown in FIG. 2 includes a second lift arm and actuator disposed on an opposite side of the of the power machine 100, although neither is shown in FIG. 2. It should be appreciated further that other lift arm assemblies, with different geometries and structures can be attached to the power machine 100 and utilize hydraulic cylinders without departing from the scope of the present discussion.

An implement carrier 130 is pivotally attached to the lift arm 116 at attachment point 132. One or more actuators such as hydraulic tilt actuator 136 shown in FIG. 2 are pivotally attached to the implement carrier 130 and the lift arm assembly 114 to cause the implement carrier to rotate under power about an axis that extends through the attachment point 132 in response to operator input. In some embodiments, the one or more actuators pivotally attached to the implement carrier and the lift arm assembly are hydraulic cylinders capable of receiving pressurized hydraulic fluid from the control system 106. The implement carrier 130 is configured to accept and secure any one of a number of different implements to the power machine as may be desired to accomplish a particular work task. The power machine 100 provides a source 134 of power and control signals that can be coupled to an implement to control various functions on the implement, in response to operator inputs. Some power machines do not have implement carriers and instead attach implements directly to lift arms. In such power machines, hydraulic tilt actuators are coupled to the implement or mounting structures that are fixed or coupled to the implement.

Power machine 100 also illustratively includes a cab 140, which is supported by the frame 102. Cab 140 defines, at least in part, an operator compartment 142. Operator compartment 142 typically includes an operator seat (not shown) and operator input devices (not shown in FIG. 2) accessible from a sitting position in the seat. When an operator is seated properly within the operator compartment, the operator can manipulate operator input devices to control such functions as driving the power machine 100, raising and lowering the lift arm assembly 114, rotating the implement carrier 130 about the lift arm assembly 114 and make power and control signals available to an implement at source 134. The signals provided at source 134 illustratively include electrical and hydraulic signals, which can be provided to electrical, electronic, and hydraulic devices on a particular implement. Operator compartment 142 can also include instrument clusters, instrument displays, and other components for providing information and receiving input from an operator.

As mentioned above, the present disclosure includes hydraulic cylinder designs and configurations that can be used in applications such as power machines. The hydraulic cylinder designs find particular usefulness in applications such as hydraulic tilt actuator 136 that advantageously employ so-called hydraulically-cushioned cylinders (described below), but hydraulic cylinders, cushioned or otherwise, in accordance with disclosed embodiments can be used in other applications on power machines, on implements attached to or attachable to power machines, or in any other cylinder application.

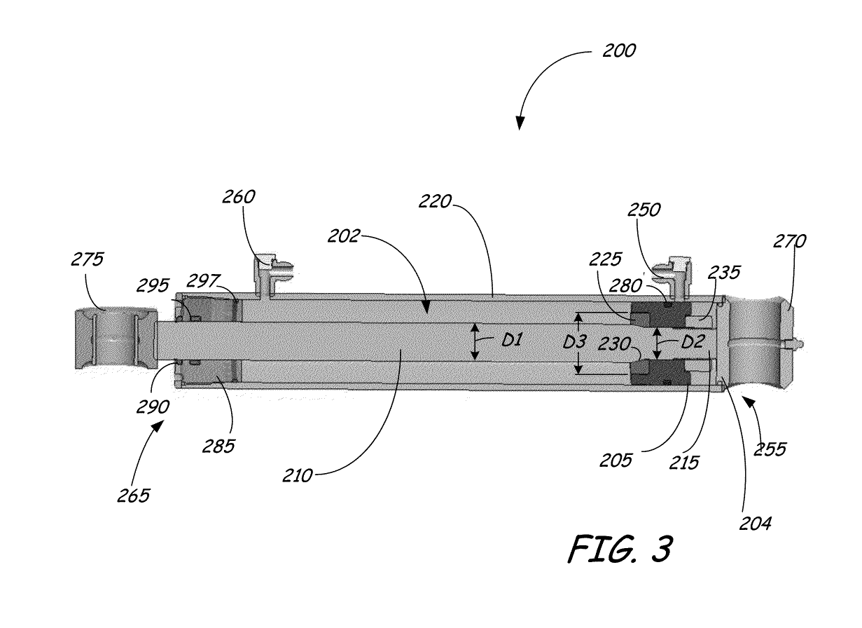

FIG. 3 illustrates a cross-section of a cylinder 200 in accordance with a first exemplary embodiment. Cylinder 200 includes a cylinder body 220 that defines, in part, a cavity 202 bounded on end by a base cap 204 and on the other end by head 285. A piston 205 is positioned in the cavity 202 and is capable of moving between the base cap 204 and the head 285. The base cap 204 and the head 285 can be attached to the cylinder body 220 via any of a number of different connection methods or using any of a number of attachment mechanisms. A rod 210 is attached to the piston 205. The rod 210 extends through the head 285 of the piston and is capable of extending and retracting from the cylinder body 220 as the piston 205 moves within the cavity 202. The attachment of the rod to the piston 205 is described in more detail below. Ports 250 and 260 are positioned to allow hydraulic fluid to be introduced into and evacuated from the cavity on opposing sides of piston 205 to cause the piston 205 to move. In power machine 100, the control system 106 selectively provides a source of hydraulic fluid to each of the ports 250 and 260 in response to manipulation of operator inputs.

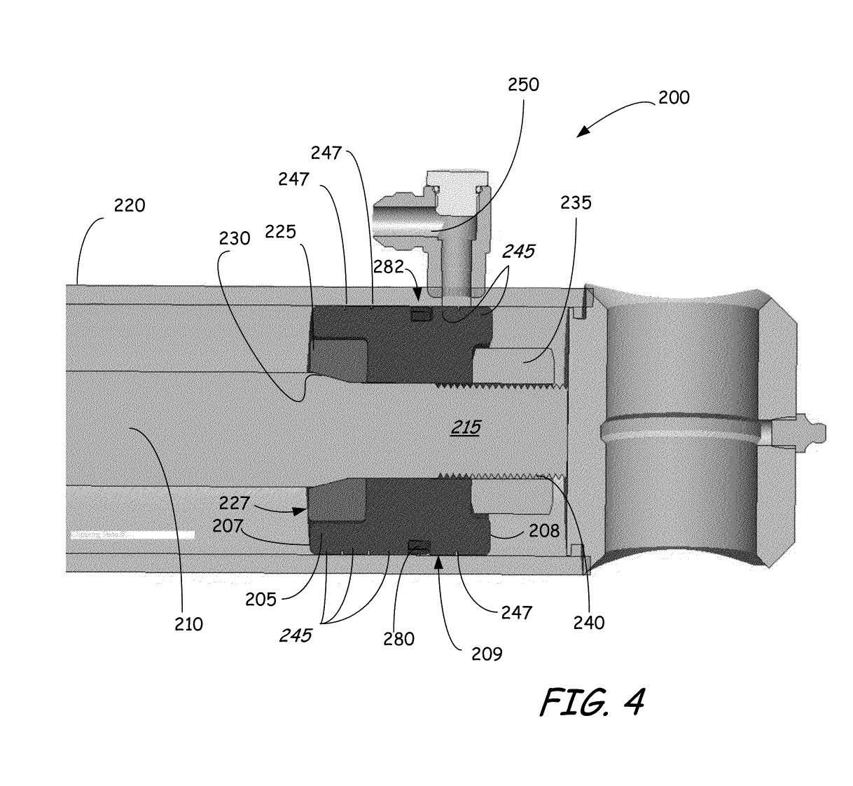

FIG. 4 illustrates a cross-section of a portion of the cylinder 200 enlarged to show the piston 205 and the connection between the piston and rod 210 in greater detail. The piston 205 has first and second opposing major surfaces 207 and 208, respectively, with a cylindrical wall 209 between the opposing major surfaces. The piston 205 is shown in a fully retracted position in each of FIGS. 3 and 4. That is, the piston 205 is positioned as closely as possible to the base cap 204. A seal 280 is fitted into a groove 282 formed into the wall 209 of the piston. The seal 280 generally prevents the migration of pressurized hydraulic fluid in the cavity 202 from one side of the piston 205 to other side. Lands 245 are formed into the wall 209 with grooves 247 being formed between each of the lands 245. The lands 245 nearest the seal 280 are of the largest diameter, with decreasing diameters for lands closer to either of the opposing major surfaces 207 and 209.

The ports 250 and 260 are positioned such that, when the piston 205 is positioned as close as possible to the base end, the piston 205 covers the port 250 and when the piston 205 is positioned as close as possible to the head, the piston 205 covers the port 260. As mentioned above, the lands 245 are of decreasing diameter from the seal 280 in either direction. Thus, when the piston 205 is moving from a center position in the cavity 202 toward one of the ends of the cavity, either the base end or the head end, as the piston approaches one of the ends, the piston 205 begins to move into alignment with either of ports 250 and 260, and fluid evacuating from the port in alignment with the piston over the port causes the path to the port to be restricted, thereby slowing the evacuation of fluid from the cavity 202 and movement of the piston toward the given end. As the piston 205 moves closer to the end, any gap between the piston and the cylinder body is reduced as larger diameter lands are positioned in alignment with the port.

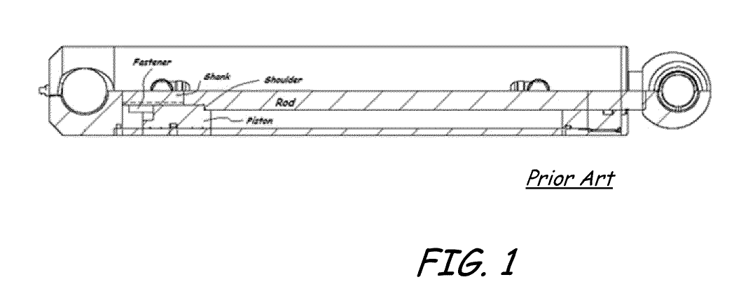

The piston 205 is carried on a reduced diameter portion of the rod 210, which is referred to as a shank 215. Most of the rod 210 has a consistent diameter D1, which is necessary to allow the rod to extend out of and retract into cylinder body 220 and remain sealed. As shown in FIGS. 3 and 4, the rod 210 has a tapered portion 230, which transitions from the diameter D1 of the rod to the shank 215, which has a diameter D2 that is less than D1. A tapered collar 225 that is sized to engage with the tapered portion 230 on the rod is fitted over the rod. The piston 205 is held against the collar 225 by a fastener 235 that provides a clamp force on the piston. As shown in FIGS. 3 and 4, a recess 227 is formed into the major surface 207 of the piston 205 to accept the tapered collar 225. The recess 227 is advantageously provided to allow the collar 225 to fit within the piston 205 and minimize the overall length of the cylinder 200. The tapered collar 225 against which the piston is positioned has a diameter D3 that is larger than the diameter D1 of the rod and therefore provides a larger surface area than does a conventional shoulder on the shaft such as is shown in FIG. 1, thereby allowing for the application of an increased clamp force on the piston 205. Threads 240 are formed into the shank 215 of the rod and the fastener 235 engages the threads to tension the shank. The threads 240 are sized so as to be capable of handling the increased clamp load applied to the piston. Because the collar 225 is provided to engage the piston 205, the shank 215 need not be reduced in size as much because the rod angled shoulder increases the bearing area and provides a surface to distribute the clamp load. Thus, the shank 215 is somewhat larger in diameter as compared to conventional designs, thereby allowing for more strength with less susceptibility to yield. When the tapered collar 225 is positioned on the shank 215 and the fastener 235 tensions the shank to hold the piston 205 against the tapered collar, a metal-to-metal sealing arrangement is provided between the collar and the rod as well as between the piston and the collar.

Also shown in FIG. 3 are cylinder components that can be included in various embodiments and for various purposes. Connection features 270 and 275 in the form of eyelets are connected to rod 210 at rod end 265 (i.e. the end of the cylinder 200 through which the rod extends) and to cylinder body 220 at base end 255 in order to couple cylinder 200 to two members, such as different arm sections, a frame and a lift arm, or a lift arm and an implement carrier, in order to move the members relative to one another as cylinder 200 is controlled to be in its extended and retracted positions. The connection features 270 and 275 are such that pivotal connections can be made between the two members to which the cylinder 200 is attached, but in other embodiments, connection features can be provided to allow for rigid connections between the cylinder an one or both of the members. Seals are provided for sealing between the head 285 and the cylinder body as between the head 285 and the rod 210. In this exemplary embodiment, the seals include wiper seal 290 and seals 295 and 297.

Many hydraulically-cushioned cylinders have a piston diameter, especially the largest lands, that is very close to an inner diameter of the cylinder body. Thus, it is important that the piston 205 be made of a compatible material to prevent scoring of the cylinder body, in the case where the piston 205 contacts the cylinder wall, such as may happen if a side load is introduced on the rod 210. As is discussed above, having a separate collar 225 of an appropriate material to absorb clamp load is advantageous. It is advantageous that the portion of the rod 210 that engages the collar is tapered to ensure that the clamp load is reacted by the collar. Because the collar 225 is tapered, however, the force from the clamp load on the collar causes hoop stress, which will deform the collar slightly and cause it to expand. The recess in the piston is shaped to accommodate this expansion. Thus, in cushioned cylinders, an increased clamp load can be applied without having to accommodate the effects of hoop stresses on the overall diameter of the piston.

While the embodiment described above is shown and described with a cushioned cylinder, the collar arrangement can be employed on any cylinder and not just cushioned cylinders. With non-cushioned cylinders, it is often the case that the diameter of the piston need not be as close to the inner wall of the cylinder body. In such applications, the piston can be made of a material that will allow the tapered collar to be integrated into the piston. Hoop stresses need to be accounted for in these applications, but the piston diameter need not be as tightly controlled because it is not being used as a cushion function.

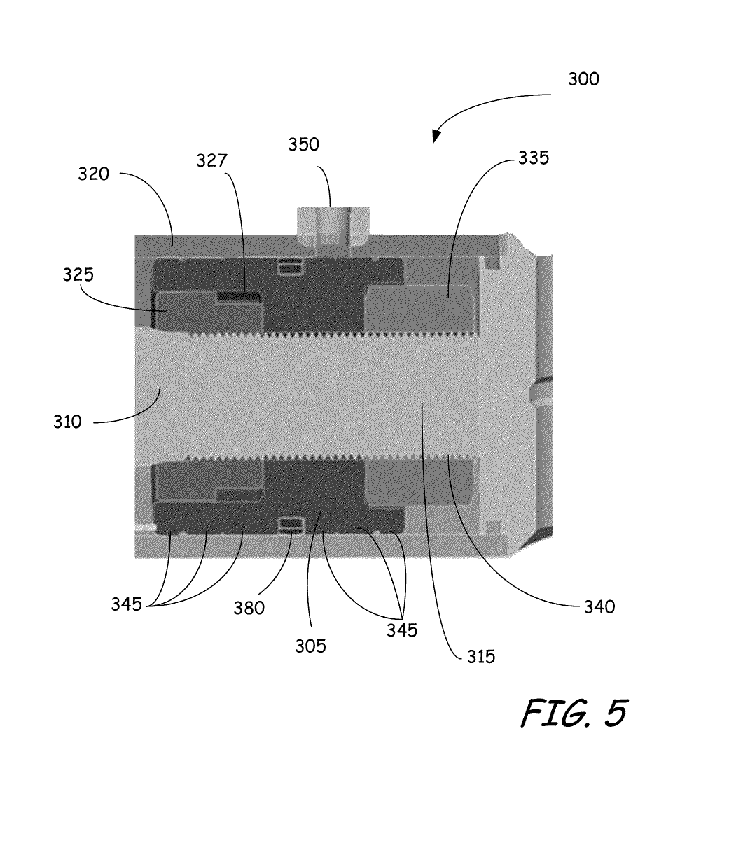

Referring now to FIG. 5, shown is a portion of a second embodiment of a hydraulic cylinder in accordance with the present disclosure. Cylinder 300 in similar to cylinder 200 described above, and therefore reference numbers in FIG. 5 used to identify features similar to those in FIGS. 3 and 4 are similar (for example, cylinder 300 has a rod 310 just as cylinder 200 has a rod 210).

Cylinder 300 has a piston 305 that coupled to rod 310 within a cylinder body 320 such that the piston is carried on shank 315 of the rod against a collar 325. The piston 305 is held against the collar 325 by a fastener 335 that provides a clamp force on the piston. Again in this embodiment, the collar 325 provides a larger surface area than a shoulder of prior art cylinders, thereby allowing for the application of a larger clamp force on the piston 305. Threads 340 on the shank connect to collar 325 and absorb the clamp load that previously transferred to the shoulder. Again, the threads 340 are sufficient to resist the shear stress of the increased clamp load. In contrast to the design of cylinder 200, in cylinder 300 shown in FIG. 5, collar 325 is threaded onto the threads 340 of shank 315 instead of being merely positioned on the shank using tapers on the shank and collar. In some embodiments, collar 325 includes gaps or flats 327 on a part of the collar. Flats 327 can be provided on the collar for allowing a wrench to be used to position the collar. Flats 327 can be located on any portion of the collar, and need not be positioned as shown in FIG. 5.

Like cylinder 200 shown in FIGS. 3 and 4, cylinder 300 is a cushioned cylinder, with a series of lands 345 and one or more grooves between the lands on piston 305. However, the features illustrated in cylinder 300 can be applied to cylinders that are not cushioned as well. A port 350 is positioned such that, when the piston 305 is fully retracted to base end, the piston 305 covers the port 350. The lands 345 may be of decreasing diameter from the seal of the piston out in either direction. Thus, when the piston 305 is moving over the port (as the piston retracts), oil is restricted, as the oil must travel between the lands 345 and the inner surface of the cylinder body 320, this part acting as an orifice. Similarly, when the piston 305 moves over the port 360 (as the piston extends toward the head), oil must travel between the lands 345 and the inner surface of the cylinder body 320, with this path acting as an orifice. In various embodiments, one, both, or neither sides of the piston (from the seal 380) can have lands 345 to provide (or not provide) hydraulic cushioning. In instances where hydraulic cushioning is not provided, the ports are positioned such that when the piston is fully retracted (or extended), the port is not fully covered by the piston, and therefore no restriction is provided between the wall of the piston and the inner diameter of the cylinder body.

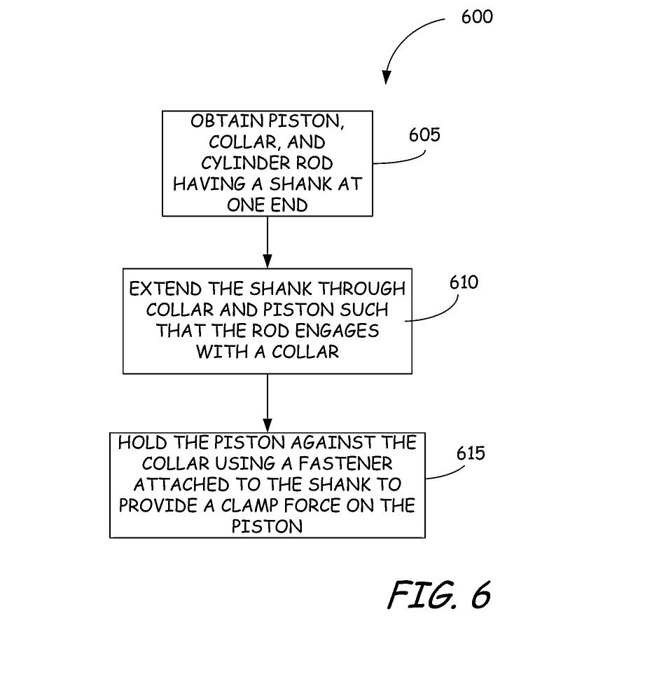

Referring now to FIG. 6, shown is a flow chart 600 illustrating one exemplary method 600 of attaching a piston to a cylinder rod. At block 605, a piston, a collar and a cylinder rod with a shank on one end are obtained. Depending upon the various embodiments used, the components obtained in block 605 are similar to those described in one or more of the embodiments described above and illustrated in FIGS. 2-5. In particular, the collar may or may not be integrated into the piston.

At block 610, the collar is placed on the rod such that the collar engaged with the rod. Engagement of the collar with the rod can be accomplished using the taper section 230 of the rod and a complementary tapered feature formed in the collar in some embodiments. In other embodiments, the engagement of the rod with the collar can be accomplished with a threaded connection between the rod and the collar.

Finally, at step 615, the piston is held against the collar using a fastener attached to the shank to provide a clamp force on the piston. In exemplary embodiments, the fastener attaches to the shank using a threaded connection between threads on the shank and threads of the fastener. However, other methods of attaching the fastener to the shank are also contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Other examples of modifications of the disclosed concepts are also possible, without departing from the scope of the disclosed concepts.

What is claimed is:

1. A hydraulic cylinder assembly comprising:
a cylinder body that defines a cavity;
a piston positioned and moveable within the cavity;
a rod having a first portion, a second portion with a cross-sectional area that is less than a cross-sectional area of the first portion, and a third portion positioned between the first and second portions, the third portion having a cross-sectional area that transitions between the cross-sectional area of the first portion and the cross-sectional area of the second portion;
a collar sized to fit over the rod, the collar having an internal feature for engaging with the third portion of the rod; and
a fastener that holds the piston against the collar and provides a clamp force on the piston.

2. The hydraulic cylinder assembly of claim 1, wherein the piston has a recess in a surface, and wherein the collar is sized to fit at least partially within the recess of the piston.

3. The hydraulic cylinder assembly of claim 1, wherein the internal feature of the collar is configured to absorb at least a portion of the clamp force.

4. The hydraulic cylinder assembly of claim 1, wherein the internal feature of the collar includes a tapered surface that engages with the third portion of the rod.

5. The hydraulic cylinder assembly of claim 1, wherein the rod includes threads, and wherein the internal feature of the collar includes threads which engage with the threads of the rod.

6. The hydraulic cylinder assembly of claim 1, wherein the second portion of the rod includes threads that engage with the fastener to provide the clamp force on the piston.

7. The hydraulic cylinder assembly of claim 1, wherein the rod includes threads which engage with corresponding threads on each of the collar and the fastener.

8. A piston assembly for use in with a hydraulic cylinder which provides a cavity, the piston assembly comprising:
a piston positionable in the cavity of the hydraulic cylinder;
a rod attached to the piston such that the rod is extendable into and retractable from the hydraulic cylinder as the piston moves within the cavity, the rod having a main portion with a first diameter and a shank with a second diameter that is less than the first diameter, the rod having a tapered portion between the main portion and the shank;
a collar sized to fit over the shank and having a tapered internal surface configured to engage with the tapered portion of the rod; and
a fastener which holds the piston against the collar and provides a clamp force on the piston.

9. The piston assembly of claim 8, wherein the tapered internal surface of the collar is disposed and arranged to absorb at least a portion of the clamp force.

10. The piston assembly of claim 9, wherein the rod includes threads which engage with corresponding threads of the collar.

11. The piston assembly of claim 10, wherein the threads of the rod that engage with the corresponding threads of the collar are on the shank of the rod.

12. The piston assembly of claim 11, wherein the threads of the rod also engage with threads on the fastener.

13. The piston assembly of claim 8, wherein the shank of the rod includes threads which engage with the fastener to provide the clamp force on the piston.

14. The piston assembly of claim 8, wherein the piston has a recess in a surface, and wherein the collar is sized to fit at least partially within the recess of the piston.

15. The piston assembly of claim 14, wherein the collar is sized to fit entirely within the recess of the piston.
